(19) United States
(12) Patent Application Publication
(10) Pub. No.: US 2007/0231440 A1
(43) Pub. Date: Oct. 4, 2007

(54) Frozen Dessert Comprising Tofu Puree

(75) Inventor: Masayoshi Taketsuka, Zama-shi (JP)

Correspondence Address: WOOD, HERRON & EVANS, LLP, 2700 CAREW TOWER, 441 VINE STREET, CINCINNATI, OH, 45202, US

(73) Assignee: MORINAGA MILK INDUSTRY CO., LTD., Tokyo (JP)

(21) Appl. No.: 11/539,259

(22) Filed: Oct. 6, 2006

(30) Foreign Application Priority Data
Mar. 29, 2006 (JP) 2006-090606

(51) Int. Cl. A23G 9/00

(52) U.S. Cl. 426/565

(57) ABSTRACT

A frozen dessert includes: 20 to 80% by mass of a tofu puree containing particles, the tofu puree having physicochemical properties of: (a) viscosity of 20 to 3,000 mPa·s; (b) dynamic storage elastic modulus of 0.2 to 600 Pa; (c) dynamic loss elastic modulus of 0.2 to 250 Pa; and (d) an average particle diameter of the particles of 2 to 15 μm and a 90% particle diameter thereof of 35 μm or smaller; and 1 to 15% by mass of an oil and fat originating from a raw material other than the tofu puree.

### BACKGROUND OF THE INVENTION

1. Field of the Invention

The present invention relates to a frozen dessert containing a tofu puree.

Priority is claimed on Japanese Patent Application No. 2006-090606, filed Mar. 29, 2006, the content of which is incorporated herein by reference.

2. Description of the Related Art

In the prior art, a frozen dessert such as so-called tofu ice cream containing a soybean product such as soymilk, tofu, or the like has been developed.

As a technique for producing a tofu paste or the like to be contained in a processed food or the like, the following methods are disclosed in documents. However, none of the documents disclose application to a frozen dessert.

(1) A method in which tofu is directly processed to a paste using a silent cutter or the like and then the paste is frozen is disclosed in Patent Document 1 (Japanese Unexamined Patent Application, First Publication No. H 6-46784).

(2) A method in which soymilk is mixed with a coagulant to obtain a coagulated product and the coagulated product is dehydrated and then processed to a paste using a high speed cutter or the like is disclosed in Patent Document 2 (Japanese Unexamined Patent Application, First Publication No. H 2-86747).

(3) A method in which soymilk is mixed with a coagulant to obtain a coagulated product and the coagulated product is processed to a paste using a homogenizer is disclosed in Patent Document 3 (Japanese Unexamined Patent Application, First Publication No. S 59-71641).

(4) Tofu puree having particular physicochemical properties and the production method thereof are disclosed in Patent Document 4 (Japanese Patent Publication No. 3327541).

As a technique for producing a frozen dessert using tofu or soymilk, the following methods are disclosed.

As a technique for using tofu to produce a frozen dessert, the following methods are disclosed.

(1) A method for producing tofu ice cream in which tofu is ground well in a mixer, milk, sugar, powdered gelatin, or the like is added to the tofu, the mixture is heated, a whipped egg yolk is added to the mixture, the mixture is cooled, whipped cream, flavor, or the like is added to the mixture, and then the mixture is hardened by cooling it is disclosed in Patent Document 5 (Japanese Unexamined Patent Application, First Publication No. H 5-227895).

(2) A method for producing ice cream in which a soybean is ground, heated, and filtered to obtain a filtrate, the filtrate is then mixed with a coagulant to obtain a tofu mixture, the tofu mixture is ground to a liquid state, and then mixed with a sugar, stabilizer, egg yolk, vegetable oil, or the like is disclosed in Patent Document 6 (Japanese Examined Patent Application, Second Publication No. H 2-55018).

As a technique for producing a frozen dessert using soymilk, the following methods are disclosed.

(3) A method for producing soymilk ice cream in which soymilk is mixed and stirred with sugars such as granulated sugar, glucose, or the like, together with a small amount of an emulsion stabilizer, and then chilled in a freezer is disclosed in Patent Document 7 (Japanese Unexamined Patent Application, First Publication No. 2004-73154).

(4) A method for producing soymilk-ice cream in which soymilk, vegetable cream, amazake with its sweetness increased by enzymatic decomposition is disclosed in Patent Document 8 (Japanese Examined Patent Application, Second Publication No. H 3-48784).

Moreover, the following methods are disclosed.

(5) A method for producing a frozen dessert in which a mixture of frozen dessert is prepared by mixing and dissolving raw materials of a frozen dessert such as a soybean protein such as soymilk or an isolated soybean protein, an oil and fat, a sugar, a stabilizer, an emulsifier, or the like, sterilizing the mixture, and then cooling the mixture while adding a coagulant such as an alkaline earth metal salt, or the like, is disclosed in Patent Document 9 (Japanese Unexamined Patent Application, First Publication No. H 11-103783).

For a frozen dessert, the texture (smoothness in the mouth) and flavor are important. Moreover, drip resistance (which is a characteristic such that the dessert hardly melts even when the temperature rises) and a shape retainability (which is a characteristic to retain an original shape even after melting begins) are particularly important for a frozen dessert. The reason for this is that theme parks and convenience stores have recently become accessible, and so the opportunity for eating outdoors has increased, particularly the opportunity for eating frozen desserts at high temperature in summer has increased.

However, the frozen desserts disclosed in the above-mentioned Patent Documents 5 to 9 lack the drip resistance and shape retainability and do not satisfy demands of the consumer.

### SUMMARY OF THE INVENTION

The present invention relates to a frozen dessert including: 20 to 80% by mass of a tofu puree containing particles, the tofu puree having physicochemical properties: (a) viscosity of 20 to 3,000 mPa·s (hereinafter, may be referred to as the condition (a)); (b) dynamic storage elastic modulus of 0.2 to 600 Pa (hereinafter, may be referred to as the condition (b)); (c) dynamic loss elastic modulus of 0.2 to 250 Pa (hereinafter, may be referred to as the condition (c)); and (d) an average particle diameter of the particles of 2 to 15 μm and a 90% particle diameter thereof of 35 μm or smaller (hereinafter, may be referred to as the condition (d)); and 1 to 15% by mass of an oil and fat originating from a raw material other than the tofu puree.

### BRIEF DESCRIPTION OF THE DRAWINGS

FIG. 1 is a drawing illustrating an embodiment of a device for manufacturing a tofu puree to be contained in a frozen dessert according to the present invention.

### DETAILED DESCRIPTION OF THE INVENTION

The present invention has as the object thereof to provide a frozen dessert excellent in drip resistance and shape retainability as well as in texture and flavor.

The frozen dessert according to the present invention is characterized by containing 20 to 80% by mass of a tofu puree having the above-mentioned physicochemical properties (a) to (d) and 1 to 15% by mass of an oil and fat originating from a raw material other than the tofu puree.

The term “frozen dessert” means a food obtained by freezing a mixture of frozen dessert (which is a mixture of raw materials to be frozen to produce a frozen dessert), the food containing ice crystals formed by freezing moisture contained in the mixture of frozen dessert. In the process of freezing the mixture of frozen dessert, the existence or nonexistence and content (over run value) of air taken in the frozen dessert are not particularly limited.

Specific examples of the frozen dessert include ice creams such as so-called tofu ice creams, so-called tofu soft-serve creams, and the like. In accordance with the Japanese classification standard, the frozen dessert is classified into 4 groups as shown in Table 1 by the content ratio of milk fat and milk solid contained in ice creams. When a frozen dessert has a low content ratio of milk fat and milk solid, the frozen dessert is classified as a sherbet in accordance with the standard. However, in this specification, ones manufactured from a tofu puree or a paste prepared using tofu or soymilk to contain a protein and an oil and fat and to have the form of ice cream such as ice cream, soft-serve cream, or the like are referred to as “ice creams”.

TABLE 1

| Classification | Milk fat Content | Milk Solid Content |
|---|---|---|
| Ice Cream | 8% or more | 15% or more |
| Iced milk | 3% or more | 10% or more |
| Lact Ice | — | 3% or more |
| Sherbet | — | less than 3% |

(Unit: “%” means “% by mass”.)

In the present invention, a tofu puree satisfying the above-mentioned conditions (a) to (d) is used.

In the present specification, the term “tofu puree” refers to one in the form of a puree obtained from soymilk or tofu. The tofu puree is preferably prepared by mixing soymilk with a coagulant to obtain a mixture, heating the mixture to obtain a coagulated product, and then grinding the coagulated product, as described below.

The condition (a) refers to viscosity of 20 to 3,000 mPa·s. When the viscosity is 20 mPa·s or more, the viscosity of a mixture of frozen dessert becomes suitable for improving the texture, drip resistance, and shape retainability of the frozen dessert. When the viscosity is 3,000 mPa·s or less, the viscosity of a mixture of frozen dessert becomes suitable for particularly improving the texture of the frozen dessert.

The viscosity of the tofu puree can be adjusted by changing as appropriate the total solid concentration of the soymilk used as a raw material, conditions for shear (dispersion and homogenization) using a first emulsifying dispersion apparatus or a second emulsifying dispersion apparatus, heating conditions, kinds or contents of the coagulant, or the like.

The method for determining the viscosity concerning the condition (a) is as follows. After each sample is left still for 24 hours at 10° C., the viscosity thereof is measured using a B-type viscometer (manufactured by TOKIMEC INC., under the trade name of DVL-BII) with No. 2 or No. 4 rotor at 60 rpm.

The condition (b) refers to dynamic storage elastic modulus of 0.2 to 600 Pa. When the dynamic storage elastic modulus is 0.2 Pa or more, the elasticity of the mixture of frozen dessert becomes suitable for particularly improving the texture, drip resistance, and shape retainability of the frozen dessert. When the dynamic storage elastic modulus is 600 Pa or less, the elasticity of the mixture of frozen dessert becomes suitable for particularly improving the texture of the frozen dessert.

The dynamic storage elastic modulus of the tofu puree can be adjusted by changing as appropriate the solid content of the soymilk used as a raw material, conditions for shear (dispersion and homogenization) using a first emulsifying dispersion apparatus or a second emulsifying dispersion apparatus, heating conditions, kinds or contents of coagulant, or the like.

The condition (c) refers to dynamic loss elastic modulus of 0.2 to 250 Pa. When the dynamic loss elastic modulus is 0.2 Pa or more, the viscosity of the mixture of frozen dessert becomes suitable for particularly improving the texture, drip resistance, and shape retainability of the frozen dessert. When the dynamic loss elastic modulus is 250 Pa or less, the viscosity of the mixture of frozen dessert becomes suitable for particularly improving the texture of the frozen dessert.

The dynamic loss elastic modulus of the tofu puree can be adjusted by changing as appropriate the solid content of the soymilk used as a raw material, conditions for shear (dispersion and homogenization) using a first emulsifying dispersion apparatus or a second emulsifying dispersion apparatus, heating conditions, kinds or contents of coagulant, or the like.

The method for determining the dynamic storage elastic modulus concerning the condition (b) and the dynamic loss elastic modulus concerning the condition (c) is as follows. After each sample is left still for 24 hours at 10° C., the dynamic storage elastic modulus and dynamic loss elastic modulus thereof are measured at 10° C. using a viscoelasticity measurement apparatus (manufactured by Rheometric Scientific FE Ltd., under the trade name of ARES) at a frequency of 50.0 rad/s.

The condition (d) refers to an average particle diameter of the particles contained in the tofu puree of 2 to 15 μm and a 90% particle diameter thereof of 35 μm or smaller. When the average particle diameter is 2 μm or larger, the texture, drip resistance, and shape retainability of the frozen dessert are particularly improved. When the average particle diameter is 15 μm or smaller, the texture is particularly improved. When the 90% particle diameter is 35 μm or smaller, the texture is particularly improved. The reason for this is that the texture is particularly influenced by the content ratio of large particles.

The average particle diameter corresponds to 50% of the particle size cumulative distribution, and the 90% particle diameter corresponds to 90% of the particle size cumulative distribution.

The average particle diameter of the particles contained in the tofu puree can be adjusted by changing as appropriate conditions for shear (dispersion and homogenization) using a first emulsifying dispersion apparatus and a second emulsifying dispersion apparatus.

The method for determining the average particle diameter and 90% particle diameter concerning the condition (d) is as follows. After each sample is left still for 24 hours at 10° C., the average particle diameter (corresponding to 50% of the particle size cumulative distribution) and 90% particle diameter (corresponding to 90% of the particle size cumulative distribution) thereof are measured using a laser diffraction-type particle size distribution measurement apparatus (manufactured by Horiba Seisakusyo Co. Ltd., under the trade name of LA-500).

The values defined in the conditions (a) to (d) are not always linked to each other. For example, there is a case in which the tofu puree satisfies the condition (a), but does not satisfy at least one of the conditions (b) to (d). However, the present inventors have found that the viscosity concerning the condition (a), the dynamic storage elastic modulus concerning the condition (b), the dynamic loss elastic modulus concerning the condition (c), and the average particle diameter and the 90% particle diameter concerning the condition (d) influence the texture, drip resistance, and shape retainability of a frozen dessert. As a result of diligent investigation, the present inventors have further found that the texture, drip resistance, and shape retainability of a frozen dessert can be improved by satisfying all of the conditions (a) to (d). Since the content of the tofu puree and the content of an oil and fat originating from a raw material other than the tofu puree also influence the texture, drip resistance, and shape retainability of a frozen dessert, these contents are also defined, as described below.

With respect to the conditions (a) to (c) in particular, although the drip resistance and shape retainability of a frozen dessert prepared using a simple liquid may be improved by merely increasing the viscosity thereof, the drip resistance and shape retainability of a melting frozen dessert prepared using a viscoelastic material such as ice creams cannot be sufficiently improved by merely defining the viscosity, since the viscoelastic material is influenced by a restoring force due to the elasticity thereof. Accordingly, factors concerning the viscoelasticity, that is, the dynamic storage elastic modulus and the dynamic loss elastic modulus, need to be defined. Thus, the drip resistance and shape retainability can be improved by combining the conditions (a) to (c) in particular.

The frozen dessert according to the present invention contains as a raw material thereof 20 to 80% by mass of the tofu puree satisfying the conditions (a) to (d). When the content of the tofu puree is 20% by mass or more, the texture, drip resistance, and shape retainability are improved. When the content of the tofu puree is 80% by mass or less, the flavor, drip resistance, and shape retainability are improved.

The frozen dessert according to the present invention further contains a raw material other than the tofu puree. An oil and fat originating from the raw material other than the tofu puree are contained in an amount of 1 to 15% by mass with respect to the total mass of the frozen dessert. When the content of the oil and fat is 1% by mass or more, the texture, drip resistance, and shape retainability are particularly improved. When the content of the oil and fat is 15% by mass or less, the texture and flavor are particularly improved.

In the claims and specification of the present application, the term “oil and fat originating from a raw material other than the tofu puree” refers to not only an oil and fat in itself but also an oil and fat component contained in a composition such as a milk product, the composition being formulated in the frozen dessert.

When the oil and fat in itself is formulated in the frozen dessert, the amount of the oil and fat to be formulated in the frozen dessert can be calculated from the mass thereof.

When the oil and fat component contained in the composition is formulated in the frozen dessert, the mass of the oil and fat is calculated from the ratio of the oil and fat in the composition, and the amount of the oil and fat to be formulated in the frozen dessert is calculated from the mass thereof.

Examples of the raw material to be formulated as a source of the oil and fat originating from the raw material other than the tofu puree include various animal and vegetable oils and fats. Specific examples thereof include a milk fat, coconut oil (a hardened coconut oil is preferably used), palm oil, soybean oil, rapeseed oil, rice bran oil, sunflower oil, olive oil, palm kernel oil, and processed oils thereof such as oils and fats subjected to hydrogenation, fractionation, interesterification, or the like. These may be used alone or in combination of at least two kinds thereof. Also, the milk product may also be used in combination with the above.

In the frozen dessert according to the present invention, other arbitrary components may be further formulated. Examples of the arbitrary components include sugars such as sucrose (granulated sugar is preferably used), glucose, fructose, oligosaccharide, invert sugar, starch syrup, powdered starch syrup, and the like, acids such as a citric acid, lactic acid, malic acid, and the like. Also, examples of additives include an emulsifier, stabilizer, and the like. Examples of the emulsifier includes a glycerine fatty acid ester, sucrose fatty acid ester, propylene fatty acid ester, organic acid ester, and the like. Examples of the stabilizer include carrageenan, guar gum, locust bean gum, sodium alginate, and the like. Also, a vanilla flavor (vanilla essence) can be preferably used. These may be used alone or in combination with at least two kinds thereof.

The raw material used for preparing the frozen dessert according to the present invention is not limited to these, and any components used for preparing conventional frozen desserts may be used. These are suitably used in accordance with the kind of frozen dessert, and the formulation ratio thereof is not particularly limited. Thus, the frozen dessert according to the present invention may contain any of these components.

The frozen dessert according to the present invention can be prepared as follows.

### (Preparation of a Tofu Puree)

The tofu puree can be preferably prepared by (A) mixing soymilk with a coagulant to obtain a mixture and holding the mixture at 40 to 90° C. to obtain a coagulated product (hereinafter, referred to as step (A)), (B) pre-crushing the coagulated product using a first emulsifying dispersion apparatus and cooling it to 10 to 35° C. to obtain a pre-crushed product (hereinafter, referred to as step (B)), and (C) crushing the pre-crushed product using a second emulsifying dispersion apparatus to particles having an average particle diameter of 2 to 15 μm and a 90% particle diameter of 35 μm or smaller (hereinafter, referred to as step (C)).

In the following, the method will be explained in more detail.

### Step (A): Preparing a coagulated product by mixing soymilk with a coagulant to obtain a mixture and holding the mixture at 40 to 90° C.

First, the coagulant is added to the soymilk to obtain the mixture and the mixture is held at 40 to 90° C. to obtain the coagulated product.

As the soymilk used as a starting raw material, any soymilk prepared in accordance with conventional methods may be used, and specific examples thereof include soymilk prepared by soaking soybeans in water for 12 hours, grinding the soaked soybeans using a grinder while adding water to obtain a ground product, steaming the ground product, and removing lees with a separator. If needed, a soy protein (such as separated soy protein (manufactured by Fuji Seiyu Co., Ltd., under the trade name of New Fujipro SE) may be suitably added to the soymilk.

When the solid content of the soymilk as a starting raw material is adjusted to 5 to 15% by mass, the conditions (a) to (d) can be easily satisfied.

As the coagulant, any substances may be used provided that they are permitted for use as a food additive and capable of coagulating soymilk. Among them, it is preferable that at least one selected from the group consisting of gluconic δ-lactone, calcium acetate, calcium gluconate, calcium lactate, calcium sulfate, calcium chloride, and magnesium chloride be used as the coagulant due to their capability of immediately coagulating the soymilk without producing any unpleasant taste.

The coagulant may be added to the soymilk in an amount capable of coagulating the soymilk. In particular, the coagulant is preferably added to the soymilk in an amount of 1 to 7% by mass with respect to the solid content of the soymilk so as to satisfy the conditions (a) to (d).

The soymilk and the coagulant are mixed uniformly so that the soymilk is homogeneously reacted with the coagulant. In the case of a batch process, it is preferable that the soymilk and the coagulant be mixed uniformly by agitating them using any of various agitators. In the case of a continuous process, it is preferable that the soymilk and the coagulant be mixed uniformly in an inline apparatus by setting the flow rate of the soymilk at 20 ml/second or higher and the coagulant addition rate at 0.2 ml/second or higher.

In order to satisfy the conditions (a) to (d), the mixture of the soymilk and the coagulant is held at 40 to 90° C. so as to produce a coagulated product. Although the holding time required for coagulating the soymilk will vary in accordance with the solid content of the soymilk as the raw material, the type of coagulant, and the amount of the coagulant added, the holding time is usually 2 to 60 seconds, and preferably 2 to 20 seconds.

In the case of the continuous process using the inline apparatus, the coagulated product can be produced by heating the soymilk preferably at 40 to 90° C. with a plate heater (such as one manufactured by Morinaga Engineering Co., Ltd.) or the like and setting the mixture of the soymilk and the coagulant at a constant flux (flow rate) through a holding pipe capable of achieving a holding time of 2 to 60 seconds.

Step (B): Preparing a pre-crushed product by pre-crushing the coagulated product using the first emulsifying dispersion apparatus and cooling it to 10 to 35° C.

The coagulated product is pre-crushed using the first emulsifying dispersion apparatus and then cooled to 10 to 35° C.

Although the first emulsifying dispersion apparatus is not particularly limited provided that it can pre-crush the coagulated product, an inline apparatus is preferably used when continuous manufacture is taken into account, and a homogenizer (such as one manufactured by Sanmaru Machinery Co. Ltd.), shear pump (such as one manufactured by Yasuda Finete) or a milder (manufactured by Ebara Seisakusyo Co., Ltd. under the trademark of Ebara Milder) is more preferably used.

By using such an apparatus, the coagulated product is usually pre-crushed to particles having an average particle diameter of 10 to 50 μm. Specifically, when the milder is used, the coagulated product can be pre-crushed to particles having a suitable average particle diameter between 10 and 50 μm by suitably varying the rotating speed of the milder between 3,000 and 15,000 rpm.

Next, the pre-crushed product is cooled to 10 to 35° C. In the case of using an inline apparatus, the pre-crushed product is cooled to the temperature by being pumped through a plate cooler (such as one manufactured by Morinaga Engineering Co., Ltd.). When the temperature is 35° C. of lower, a favorable tofu puree satisfying the conditions (a) to (d) can be produced even if overheating occurs as a result of frictional heat in the subsequent crushing step. When the temperature is 10° C. of higher, the pre-crushed product is prevented from gaining an increased viscosity and sufficiently crushed, and so can be sufficiently dispersed by the subsequent treatment using the second emulsifying dispersion apparatus.

### Step (C): Crushing the pre-crushed product using the second emulsifying dispersion apparatus to particles having an average particle diameter of 2 to 15 μm and a 90% particle diameter of 35 μm or smaller.

The tofu puree satisfying the conditions (a) to (d) is produced by crushing the pre-crushed product using the second emulsifying dispersion apparatus to particles having an average particle diameter of 2 to 15 μm and a 90% particle diameter of 35 μm or smaller.

Although the second emulsifying dispersion apparatus is not particularly limited provided that the apparatus is capable of further crushing the particles contained in the pre-crushed product to an average particle diameter of 2 to 15 μm and a 90% particle diameter of 35 μm or smaller, an inline apparatus is preferably used when continuous manufacture is taken into account, and a homogenizer (such as one manufactured by Sanmaru Machinery Co. Ltd.), a shear pump (such as one manufactured by Yasuda Finete), or a milder (such as one manufactured by Ebara Seisakusyo Co., Ltd. under the trademark of Ebara Milder) is preferably used.

Specifically, when the homogenizer is used for crushing, the particles contained in the pre-crushed product are crushed to an average particle diameter of 2 to 15 μm and a 90% particle diameter of 35 μm or smaller by suitably varying the treatment pressure to between 2 and 150 MPa. In this case, in order to prevent the tofu puree from being heated by frictional heat, it is preferable that crushing is carried out while cooling the product to keep it at a constant temperature, for example, 25° C., or lower.

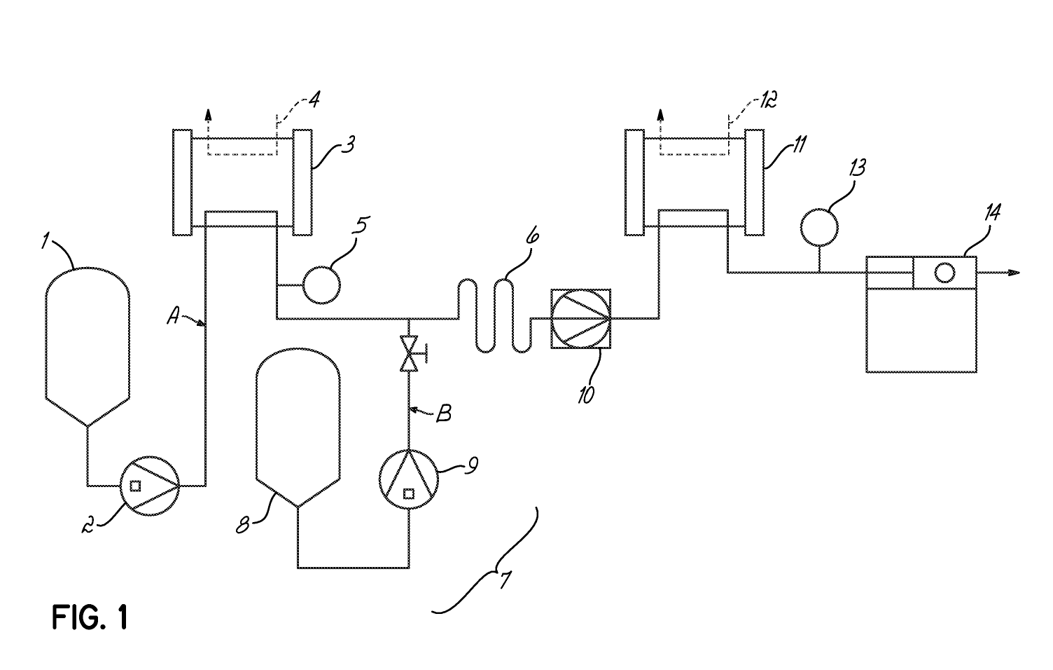

It is preferable that these steps (A) to (C) be carried out using an inline device as illustrated in FIG. 1, for example.

FIG. 1 is a schematic diagram illustrating an embodiment of a device for manufacturing a tofu puree. The manufacturing device is schematically composed of a system in which a raw material tank 1, a heating apparatus 3, a holding pipe 6, a first emulsifying dispersion apparatus 10, a cooling apparatus 11, and a second emulsifying dispersion apparatus 14 are connected in this order through a line A and a coagulant supply apparatus 7 for supplying a coagulant, the coagulant supply apparatus 7 being linked via a line B to the line A between the heating apparatus 3 and the holding pipe 6.

The raw material tank 1 may be any type of tank provided that it can hold soymilk and is sanitary for food handling.

On the line A, a metering pump 2 with a flux regulator valve is disposed downstream from the raw material tank 1, and the heating apparatus 3 is disposed downstream from the metering pump 2.

The heating apparatus 3 is an apparatus with a heat source 4 for heating a liquid, and examples thereof include a plate heater, a tubular heater, and other heat exchangers. Examples of the heat source 4 include steam, hot water, and the like.

At an outlet of the heating apparatus 3, a temperature controller 5 that automatically controls the temperature of the liquid at the outlet is disposed. The heating apparatus 3 need not be a single device, and may be one capable of heating in stages by a plurality of heat exchangers.

The holding pipe 6 is disposed downstream from the temperature controller 5. The holding pipe 6 holds the mixture of the soymilk and the coagulant for a specific time at a constant temperature to form the coagulated product.

The line B extending from the coagulant supply apparatus 7 for supplying the coagulant is linked to the line A at a position between the heating apparatus 3 and the holding pipe 6.

The coagulant supply apparatus 7 includes a coagulant tank 8 and a metering pump 9 with a flux regulator valve, and is capable of supplying the coagulant in specific amounts to the soymilk that has been heated at 40 to 90° C. by the heating apparatus.

The first emulsifying dispersion apparatus 10 is disposed downstream from the holding pipe 6 in the line A. The first emulsifying dispersion apparatus 10 is not particularly limited provided that it can pre-crush the coagulated product, and a shear pump or a milder is preferably used.

The cooling apparatus 11 is disposed downstream from the first emulsifying dispersion apparatus 10 in the line A. The cooling apparatus 11 is an apparatus with a refrigerant supply apparatus 12 and is used for cooling a liquid. Examples of the cooling apparatus 11 include a plate cooler, a tubular heater, and other heat exchangers. Examples of refrigerant used in the refrigerant supply apparatus 12 include water, chilled water, and the like.

In the vicinity of an outlet of the cooling apparatus 11 on the line A, a temperature controller 13 that automatically controls the temperature of a liquid at the outlet is disposed. The cooling apparatus 11 need not be a single apparatus, and may be one capable of heating in stages by a plurality of heat exchangers.

The second emulsifying dispersion apparatus 14 is disposed downstream from the cooling apparatus 11. The second emulsifying dispersion apparatus 14 is not particularly limited provided that it can crush the pre-crushed product to particles having a particular average particle diameter and 90% particle diameter, and examples thereof include a homogenizer, a shear pump, and a milder.

It is preferable that each component of the device be sterilely sealed and the tofu puree be sterilely manufactured so as to enable large-scale production without microbial contamination.

In the following, the method for manufacturing the tofu puree using the device will be explained in more detail.

First, soymilk is put into the raw material tank 1. Next, the soymilk is supplied to the heating apparatus 3 by operating the metering pump 2, and the soymilk is heated by operating the heat source 4. The temperature of the heated soymilk is controlled using the temperature controller 5. Next, the heated soymilk is supplied to the holding pipe 6.

On the other hand, a coagulant is put into the coagulant tank 8. Then, the coagulant is supplied from the line B to the line A linked therewith at the position between the heating apparatus 3 and the holding pipe 6 by operating the metering pump 9. Thus, the soymilk and the coagulant are mixed together at an upstream portion from the holding pipe 6, and the mixture is held at a predetermined temperature inside the holding pipe 6, as a result of which a coagulated product is produced (see the above-mentioned Step (A)).

Next, this coagulated product is supplied to the first emulsifying dispersion apparatus 10, pre-crushed, supplied to the cooling apparatus 11, and then cooled by operating the refrigerant supply apparatus 12, as a result of which a pre-crushed product is produced. The cooling temperature is controlled using the temperature controller 13 disposed downstream from the refrigerant supply apparatus 12 (see the above-mentioned Step (B)).

Next, this pre-crushed product is supplied to the second emulsifying dispersion apparatus 14 and crushed to the particles satisfying the conditions (a) to (d), and thus the tofu puree is produced (see the above-mentioned Step (C)).

### Manufacturing a Frozen Dessert.

By using the tofu puree prepared as described above, a frozen dessert can be manufactured. For example, ice cream is manufactured by uniformly mixing the tofu puree with other raw materials for supplying an oil and fat, a granulated sugar, and the like, to prepare a mixture for ice cream, and then cooling the mixture for ice cream. In the following, a specific example of the manufacturing method will be explained.

The tofu puree is heated to 50° C., and the raw materials other than the tofu puree are added to the tofu purre, and then dispersed and dissolved in the tofu puree using a homomixer at 6,000 rpm for 2 minutes. The mixture is sterilized by heating it at 85° C. for 10 minutes, homogenized under the pressure of 15 MPa using a homogenizer, and then cooled to 10° C., and thus a mixture for ice cream is prepared. The mixture for ice cream is frozen in a freezer, and thus the ice cream is manufactured. It is preferable that the ice cream be filled in a paper container and stored at approximately −18° C.

As described above, the frozen dessert according to the present invention is a novel type of frozen dessert with excellent texture, flavor, drip resistance, and shape retainability, which cannot be exhibited by conventional products.

As will be clear from examples described below, a tofu paste prepared by directly processing a tofu into a paste, or coagulating a mixture of a soymilk and a coagulant followed by dehydrating and processing the coagulant into a paste has physicochemical properties exceeding the upper limits defined in the conditions (a) to (d). The tofu paste has a graininess and unfavorable texture. Accordingly, a frozen dessert containing the tofu paste has an unfavorable texture.

In the case that soymilk is directly used to manufacture a frozen dessert, the frozen dessert gains a green flavor, astringency, beany flavor, and the like, which are inherent in soybeans, and the flavor thereof is unfavorable. Moreover, a frozen dessert with particularly excellent drip resistance and shape retainability cannot be manufactured. On the other hand, when a frozen dessert is manufactured from a paste prepared by mixing a soymilk with a coagulant without being followed by homogenizing the mixture, or followed by homogenizing the mixture using a homogenizer alone, the paste has an average particle diameter exceeding 15 μm and a 90% particle diameter exceeding 35 μm, and so the texture thereof becomes unfavorable.

In contrast, the frozen dessert according to the present invention is a novel type without any problems of conventional frozen desserts prepared from such a soybean product as described above. The reason the frozen dessert according to the present invention is excellent in texture, flavor, drip resistance, and shape retainability is not certain, although the following is supposed as the reason. The texture, flavor, drip resistance, and shape retainability of a frozen dessert, although they may also be influenced by other conditions, generally depend on the viscosity of the mixture of frozen dessert, the amount of the oil and fat, the state of oil (fat) globules, the particle size distribution of oil (fat) globules or the tofu puree, or the like. These are considered to influence the texture, the state of ice crystals or air bubbles, the state of emulsified or demulsified and condensed oil and fat, and the like, when a frozen dessert is formed. It is considered that the condition (d) defining the sharp particle size distribution causes fineness and smoothness of the particles to be contained in the frozen dessert, and the conditions (a) to (c) defining the suitable viscosity, dynamic storage elastic modulus, and dynamic loss elastic modulus of the tofu puree give a suitable viscoelasticity to the mixture of frozen dessert in which the tofu puree is mixed with another oil and fat in a particular ratio, and form a structure excellent in the drip resistance and shape retainability by the protein denatured by the coagulant together with the oil and fat originating from another raw material when the denatured protein and the oil and fat are frozen together. Thus, the frozen dessert with excellent texture, flavor, drip resistance, and shape retainability can be manufactured.

### EXAMPLES

Hereinafter, the present invention will be explained in more detail with reference to Examples. However, it is apparent that the present invention is not limited to these Examples. Also, “parts” and “%” used in the examples indicate “parts by mass” and “% by mass” unless otherwise so indicated.

### Preparation of Soymilk and Tofu.

### Reference Example 1

### Preparation of Soymilk

60 kg of American soybeans (imported by HONDA TRADING CORPORATION. under the trade name of GL 2930) were washed and hulled and then were allowed to swell by being immersed in flowing water for 12 hours. The swollen soybeans were supplied together with 170 kg of water to a grinder (manufactured by Nagasawa Kikai Seisakusho Co., Ltd.) and ground so that approximately 220 kg of soybean slurry (i.e. raw soy) was obtained. 220 kg of the soybean slurry was steamed for 4 minutes at 100° C. using a continuous cooking kettle (manufactured by Nagasawa Kikai Seisakusho Co., Ltd.), and separated into soymilk and tofu lees using a press (manufactured by Arai Tekkousho) so that approximately 190 kg of soymilk was obtained. The solid content of the obtained soymilk was approximately 13.0%.

### Reference Example 2

### Preparation of Tofu

60 kg of the same American soybeans as those used in Reference Example 1 were immersed to be swollen. The swollen soybeans were supplied together with 570 kg of water to a grinder (manufactured by Nagasawa Kikai Seisakusho Co., Ltd.) and ground so that approximately 620 kg of soybean slurry (i.e. raw go) was obtained. 620 kg of the soybean slurry was steamed for 4 minutes at 100° C. using a continuous cooking kettle (manufactured by Nagasawa Kikai Seisakusho Co., Ltd.), and separated into soymilk and tofu lees using a press (manufactured by Arai Tekkousho.) so that approximately 600 kg of soymilk was obtained. The solid content of the obtained soymilk was approximately 4.5%. After 100 kg ofthe soymilk was cooled to 70 to 75° C., calcium sulfate (manufactured by Tomita Pharmaceutical Co., Ltd.) that had been suspended in lukewarm water was added at a density of 7.8% of the soymilk solid component and the soymilk and calcium sulfate were mixed. The mixture was then left for 10 minutes. After the obtained coagulated substance had been lightly broken down, it was moved to a die case and pressed for 20 minutes so that approximately 80 kg of tofu was obtained. This tofu was then soaked in water and cooled, and was then cut. Thus, firm type tofu (Momen-tofu) was obtained. The water content of the firm type tofu was approximately 87%.

### Example 1-1

### (1) Preparation of Tofu Puree

A tofu puree was prepared using a tofu puree manufacturing device shown in FIG. 1.

100 kg of soymilk prepared by the same method as in Reference Example 1 to have a solid content of 13%, the soymilk being held at 10° C. in the raw material tank 1, was pumped to the heating apparatus 3 using the metering pump 2 equipped with a flux regulator valve (manufactured by NAKAKIN CO., LTD.). The soymilk that flowed into the heating apparatus 3 was heated by hot water of the heat source 4 kept at 60° C. by the temperature controller 5 (manufactured by Yokokawa Electric Corporation), and pumped toward the holding pipe 6 at 28 ml/second in a constant flux.

A coagulant (magnesium chloride manufactured by Nichia Chemical Industries) contained in the coagulant tank 8 (manufactured by Morinaga Engineering Co., Ltd.) of the coagulant supply apparatus 7 was supplied at 0.4 ml/second in a flux so as to be added in an amount of 4% with respect to the solid content of the soymilk to the soymilk pumped from the heating apparatus 3 using the metering pump 9 equipped with the flux regulator valve (manufactured by FMI Corporation), and the coagulant and soymilk were uniformly mixed together. The mixture was held for 3 seconds at 60° C. by the holding pipe 6 to produce a coagulated product, and the coagulated product was transferred to the first emulsifying dispersion apparatus 10 (manufactured by Ebara Seisakusyo Co., Ltd. under the trade name of Miilder).

Next, the coagulated product transferred to the first emulsifying dispersion apparatus 10 was immediately pre-crushed to particles having an average particle diameter of 20 μm at a rotation speed of 12,000 rpm in a Milder, and then transferred to the cooling apparatus 11. The pre-crushed product transferred to the cooling apparatus 11 was cooled by chilled water (refrigerant 12) kept at 30° C. by the temperature controller 13 (manufactured by Yokokawa Electric Corporation), and transferred to the second emulsifying dispersion apparatus 14 (homogenizer, manufactured by Sanmaru Machinery Co. Ltd.).

The pre-crushed product transferred to the second emulsifying dispersion apparatus 14 was crushed to particles having an average particle diameter of 13.4 μm and a 90% particle diameter of 23.1 μm at a treatment pressure of 12 MPa.

The tofu puree thus obtained had no graininess and a favorable flavor.

### (2) Preparation of Ice Cream Containing Tofu Puree.

70.5 kg of the tofu puree obtained above was heated to 50° C., to which 12.0 kg of granulated sugar, 8.5 kg of powdered starch syrup (manufactured by Showa Sangyo Co. Ltd.), 8.0 kg of hardened coconut oil (manufactured by TAIYO YUSHI K.K.), 0.3 kg of glycerine fatty acid ester, 0.1 kg of carrageenan, 0.1 kg of guar gum, 0.1 kg of locust bean gum, and 0.3% vanilla flavor (manufactured by San-Ei Gen. F.F.I., Inc) were added, dispersed, and then dissolved using a homomixer (manufactured by TOKUSHU KIKA KOGYO K.K.) at 6,000 rpm for 2 minutes to obtain a mixture. This mixture was sterilized by heating at 85° C. for 10 seconds, homogenized using a homogenizer (manufactured by Sanmaru Machinery Co. Ltd.) at a treatment pressure of 15 MPa, and cooled to 10° C., and thus a mixture for ice cream was obtained. The mixture for ice cream was frozen in an ice cream freezer (manufactured by CARPIGIANI under the trade name of L12/C), and an over run (the mass ratio of air) thereof was adjusted to 65%, and thus tofu ice cream was obtained. After this ice cream was filled in a paper container with a capacity of 100 cc, the paper container with the ice cream was sealed and stored at −18° C. for 24 hours. Then, the ice cream was evaluated in accordance with the following method.

### Example 1-2

### (1) Preparation of Tofu Puree

A tofu puree was prepared using a tofu puree manufacturing device shown in FIG. 1 in a similar manner to that of Example 1-1, except that some of the manufacturing conditions were changed.

100 kg of soymilk with 13% solid content at 10° C., the soymilk being manufactured by the same method as in Reference Example 1, was placed in the raw material tank 1, pumped to the heating apparatus 3, and then heated at 80° C. by the heating apparatus 3. To the heated soymilk, a coagulant (magnesium chloride manufactured by Nichia Chemical Industries) was supplied from the coagulant supply apparatus 7 at a ratio of 4% with respect to the solid content of the soymilk, and the coagulant and soymilk were uniformly mixed together. The mixture was held for 3 seconds at 80° C. in the holding pipe 6 to produce a coagulated product, and the coagulated product was immediately pre-crushed to particles having an average particle diameter of 10 μm using the first emulsifying dispersion apparatus 10 at a rotation speed of 12,000 rpm, and then transferred to the cooling apparatus 11. The pre-crushed product was cooled to 30° C. using the cooling apparatus 11.

The pre-crushed product was immediately crushed to particles having an average particle diameter of 4.8 μm and a 90% particle diameter of 8.0 μm using the second emulsifying dispersion apparatus 14 at a treatment pressure of 3 MPa. The tofu puree thus obtained had no graininess and favorable flavor.

### (2) Preparation of Ice Cream Containing Tofu Puree.

60 kg of the tofu puree obtained above was heated to 50° C., to which 12.0 kg of granulated sugar, 8.5 kg of powdered starch syrup (manufactured by Showa Sangyo Co. Ltd.), 5.0 kg of soybean oil (manufactured by TAIYO YUSHI K.K.), 0.3 kg of glycerine fatty acid ester, 0.05 kg of carrageenan, 0.1 kg of guar gum, 0.1 kg of locust bean gum, 0.05 kg of sodium alginate, and 0.3% vanilla flavor (manufactured by San-Ei Gen. F.FI., Inc) were added and mixed together. The mixture was dispersed and dissolved using a homomixer (manufactured by TOKUSHU KIKA KOGYO K.K.) at 6,000 rpm for 2 minutes. This was sterilized by heating at 110° C. for 2 seconds, homogenized using a homogenizer (manufactured by Sanraru Machinery Co. Ltd.) at a treatment pressure of 15 MPa, and cooled to 10° C., and thus a mixture for ice cream was obtained. The mixture for ice cream was frozen in an ice cream freezer (manufactured by CARPIGIANI under the trade name of L12/C), and an over run thereof was adjusted to 70%, and thus tofu ice cream was obtained. This ice cream was filled in a paper container with a capacity of 100 cc, and the paper container with the ice cream was sealed and stored at −18° C. for 24 hours. Then, the ice cream was evaluated in accordance with the following method.

### Comparative Example 1-1

Ice cream was prepared as a sample in accordance with a method similar to that of Example 1-1, except that a tofu paste prepared by processing the firm type tofu obtained in Reference Example 2 into a paste using a silent cutter in accordance with a method disclosed in Example 1 of Patent Document 1 was used instead of the tofu puree of Example 1-1.

### Comparative Example 1-2

Ice cream was prepared as a sample in accordance with a method similar to that of Example 1-1, except that a paste prepared by adding 4.4 g of gluconic δ-lactone as a coagulant to 2 kg of the soymilk obtained in Reference Example 1, leaving the mixture to stand at 80° C. for 30 minutes to coagulate the soymilk, thereby obtaining a coagulated product (of which a soybean solid content was 8%), followed by pressing the coagulated product for 30 minutes using a press at 0.2 to 1.0 kg/cm² to dehydrate it to obtain a dehydrated product with 73% moisture content, and then processing the dehydrated product into a paste using a high speed cutter in accordance with a method disclosed in Example 1 of Patent Document 2 was used instead of the tofu puree of Example 1-1.

### Comparative Example 1-3

Ice cream was prepared as a sample in accordance with a method similar to that of Example 1-1, except that a paste prepared by heating the soymilk of Reference Example 1 at 80° C., mixing the heated soymilk with a coagulant in which 2.5 g of calcium chloride, 1.5 g of magnesium chloride, and 3.5 g of citric acid were dissolved into 175 g of water, keeping the mixture at 80° C. for 5 seconds to obtain a coagulated product, and processing the coagulated product into a paste using a homogenizer in accordance with a method disclosed in an example of Patent Document 3 was used instead of the tofu puree of Example 1-1.

### Comparative Example 1-4

Ice cream was prepared as a sample in accordance with a method similar to that of Example 1-1, except that a paste prepared by adding magnesium chloride as a coagulant to the soymilk obtained in Reference Example 1 at a ratio of 4% with respect to the solid content of the soymilk, uniformly mixing them, keeping the mixture at 80° C. for 5 seconds to obtain a coagulated product, and processing the coagulated product into a paste using a homogenizer in accordance with a method disclosed in an example of Patent Document 3 was used instead of the tofu puree of Example 1-1.

### Comparative Example 1-5

Ice cream was prepared as a sample in accordance with a method similar to that of Example 1-1, except that a mixture for ice cream prepared by sufficiently grinding the firm type tofu obtained in Reference Example 2 using a mixer to obtain 2 kg of tofu paste, and mixing the tofu paste with 4 kg of milk, 800 g of sugar, 80 g of gelatin, 1500 cc of whipped fresh cream, and a small amount of vanilla essence in accordance with a method disclosed in an example of Patent Document 5 was used instead of the mixture for ice cream of Example 1-1.

### Comparative Example 1-6

Ice cream was prepared as a sample in accordance with a method similar to that of Example 1-1, except that a mixture for ice cream prepared by mixing at 10° C. 2910 g of the soymilk obtained in Reference Example 1 with a coagulant in which 18 g of magnesium chloride was dissolved in 72 g of water to coagulate the soymilk, thereby obtaining a tofu mixture, and then sufficiently grinding the tofu mixture using a mixer to obtain 787 g of a paste (in a liquid state), followed by mixing the paste with 120 g of sugar, 3 g of stabilizer (carrageenan), 10 g of egg yolk, and 80 g of vegetable oil in accordance with a method disclosed in Patent Document 6 was used instead of the mixture for ice cream of Example 1-1.

### Comparative Example 1-7

Ice cream was prepared as a sample in accordance with a method similar to that of Example 1-1, except that a mixture for ice cream prepared by mixing 2352 g of the soymilk obtained in Reference Example 1 with 44.1 g of granulated sugar, 14.7 g of glucose, and 6.0 g of stabilizer (carrageenan) in accordance with a method disclosed in an example of Patent Document 7 was used instead of the mixture for ice cream of Example 1-1.

### Comparative Example 1-8

Ice cream was prepared as a sample in accordance with a method similar to that of Example 1-1, except that a mixture for ice cream prepared by adding 925 g of amazake obtained from enzyme-treated malted rice and 440 g of water to 2425 g of the soymilk obtained in Reference Example 1, heating them at approximately 80° C., and sufficiently mixing for approximately 5 minutes, followed by cooling the mixture to 3° C., and adding to the mixture while stirring 1210 g of vegetable cream in which 505 g of palm oil, 505 g of coconut oil, and 200 g of soybean oil were mixed and emulsified in accordance with a method disclosed in an example of Patent Document 8 was used instead of the mixture for ice cream of Example 1-1.

### Comparative Example 1-9

Ice cream was prepared as a sample in accordance with a method similar to that of Example 1-1, except that a mixture for ice cream prepared by mixing 70.0 parts of the soymilk obtained in Reference Example 1 with other raw materials (8.0 parts of granulated sugar, 8.0 parts of malt sugar, 3.82 parts of powdered starch syrup, 2.0 parts of water, and 8.0 parts of coconut oil) until the raw materials were dissolved in the soymilk to obtain a mixture, sterilizing the mixture, cooling the sterilized mixture to 50° C., adding 0.6 parts (24 g) of coagulant (50% solution of magnesium chloride) to the mixture at 50° C., and then further cooling the mixture to 5° C. in accordance with a method disclosed in an example of Patent Document 9 was used instead of the mixture for ice cream of Example 1-1.

### Comparative Example 1-10

As a control with respect to the ice creams containing a soybean component, an ice cream containing a milk product was prepared.

26.41 g of fresh cream, 11.91 g of condensed skim milk, and 5.24 g of powdered skim milk were mixed together to prepare a mixture for ice cream. The mixture for ice cream was frozen in the same way as in Example 1-1, and thus ice cream was obtained as a control sample. Raw materials used above and formulation ratios thereof were determined in accordance with “Manufacturing ice cream” (Editor: Korehira Yuyama, Publisher: KORIN PUBLISHING CO., LTD., Publication Date: Apr. 30, 1996, Page 61).

### Evaluation

### (1) Measuring the Physicochemical Properties (a) to (d) of Tofu Puree.

The method for measuring the physicochemical properties (a) to (d) of tofu puree are described above.

### (2) Evaluation of Characteristics of Frozen Dessert

(i) Evaluation of Drip Resistance

Each frozen sample was taken out from each paper container, and the sample was placed on a 2-mm-aperture metallic mesh in a temperature-controlled room (25° C.) while being shielded to prevent the sample from being influenced by air convection, and thus the sample was naturally melted. Then, the time required for the first drip to fall from the sample naturally melted was measured and recorded.

(ii) Evaluation of Shape Retainability

Each frozen sample was taken out from each paper container, and the sample was placed on a 2-mm-aperture metallic mesh in a temperature-controlled room (25° C.) while being shielded to prevent the sample from being influenced by air convection, and thus the sample was naturally melted. Then, the amount of the sample dropped by natural melting was measured with time.

The mass ratio of the sample dropped by natural melting with respect to the total mass of the sample before melting (melting ratio: % by mass) was calculated and the time required for the melting ratio to become 50% was recorded.

(iii) Evaluation of Texture

Each sample was subjected to a sensory test by a panel composed of 20 men and women, ages 20 to 40. Each sample was evaluated by each panelist in accordance with the following criteria.
0 points: good texture.
1 point: fair texture.
2 points: somewhat poor texture.
3 points: poor texture.

The score for each sample was averaged, and the averaged value was evaluated in accordance with the following criteria.
Good: 0.5 points or less.
Fair good: at least 0.5 but less than 1.5 points.
Somewhat poor: at least 1.5 but less than 2.5 points.
Poor: at least 2.5 but less than 3.0 points.
   (iv) Evaluation of Flavor

Each sample was subjected to a sensory test by a panel composed of 20 men and women, ages 20 to 40. Each sample was evaluated by each panelist in accordance with the following criteria.
0 points: good flavor.
1 point: fair flavor.
2 points: somewhat poor flavor.
3 points: poor flavor.

The score for each sample was averaged, and the averaged value was evaluated in accordance with the following criteria.
Good: 0.5 points or less.
Fair good: at least 0.5 but less than 1.5 points.
Somewhat poor: at least 1.5 but less than 2.5 points.
Poor: at least 2.5 but less than 3.0 points.

### Test Example 1

### Comparison with Prior Art

Each sample (ice creamy) of the examples or comparative examples was evaluated, as follows. Physicochemical properties of the tofu purees in Examples 1-1 and 1-2 are shown in Table. 2. Also, physicochemical properties of the pastes prepared from the tofu or soymilk in Comparative Examples 1-1 to 1-6 are shown in Table. 2. Also, results of the samples are shown in Table. 3.

TABLE 2

| | | (b) | (c) | (d) | (d) |
|---|---|---|---|---|---|
| | (a) | Dynamic storage | Dynamic loss | Average particle | 90% particle |
| | Viscosity | elastic modulus | elastic modulus | diameter | diameter |
| | (mPa · s) | (Pa) | (Pa) | (μm) | (μm) |
| Example | 1100 | 14.5 | 8.7 | 13.4 | 23.1 |
| 1-1 | | | | | |
| Example | 233 | 1.5 | 1.1 | 4.8 | 8.0 |
| 1-2 | | | | | |
| Comparative | 5010 | 3700.0 | 1200.1 | 22.4 | 54.0 |
| Example | | | | | |
| 1-1 | | | | | |
| Comparative | 7200 | 3850.4 | 1400.2 | 16.2 | 49.1 |
| Example | | | | | |
| 1-2 | | | | | |
| Comparative | 430 | 1.9 | 1.9 | 17.4 | 42.4 |
| Example | | | | | |
| 1-3 | | | | | |
| Comparative | 410 | 0.5 | 0.4 | 18.1 | 43.0 |
| Example | | | | | |
| 1-4 | | | | | |
| Comparative | 5000 | 3650.0 | 1150.0 | 22.0 | 53.0 |
| Example | | | | | |
| 1-5 | | | | | |
| Comparative | 3100 | 2505.0 | 780.0 | 21.5 | 52.5 |
| Example | | | | | |
| 1-6 | | | | | |

TABLE 3

| | | | | Shape |
|---|---|---|---|---|
| | | | Dripping start time | retainability |
| | Texture | Flavor | (minutes) | (minutes) |
| Example | Good | Good | 65 | 100 |
| 1-1 | | | | |
| Example | Good | Good | 68 | 110 |
| 1-2 | | | | |
| Comparative | Poor | Somewhat | 60 | 95 |
| Example | | poor | | |
| 1-1 | | | | |
| Comparative | Poor | Somewhat | 60 | 97 |
| Example | | poor | | |
| 1-2 | | | | |
| Comparative | Somewhat | Somewhat | 59 | 95 |
| Example | poor | poor | | |
| 1-3 | | | | |
| Comparative | Somewhat | Somewhat | 60 | 98 |
| Example | poor | poor | | |
| 1-4 | | | | |
| Comparative | Poor | Somewhat | 60 | 96 |
| Example | | poor | | |
| 1-5 | | | | |
| Comparative | Somewhat | Somewhat | 60 | 93 |
| Example | poor | poor | | |
| 1-6 | | | | |
| Comparative | Somewhat | Poor | 30 | 65 |
| Example | poor | | | |
| 1-7 | | | | |
| Comparative | Somewhat | Poor | 31 | 67 |
| Example | poor | | | |
| 1-8 | | | | |
| Comparative | Somewhat | Somewhat | 60 | 90 |
| Example | poor | poor | | |
| 1-9 | | | | |
| Comparative | Good | Good | 31 | 68 |
| Example | | | | |
| 1-10 | | | | |

The samples of Examples 1-1 and 1-2 are superior to the samples of Comparative Examples 1-1 to 1-9 prepared in accordance with the methods disclosed in Patent Documents 1 to 3 and 5 to 9 in terms of texture, flavor, drip resistance and shape retainability. Thus, it was confirmed that the ice creams prepared in accordance with the present invention by using the materials with particular properties have characteristics superior to and different from those of the conventional ice creams containing tofu or soymilk.

Also, the ice creams prepared in the examples are superior to the ice creams prepared in Comparative Example 1-10 by using the conventional milk product in terms of drip resistance and shape retainability, and thus confirmed to be excellent in product characteristics.

When other tests were carried out by the same way as described above, except that the kind of soymilk or tofu was suitably changed, similar results were obtained.

### Test Example 2

### Comparison of Tofu Purees with Different Physicochemical Properties

Effects on the conditions (a) to (d) were examined.

### (1) Preparation of Samples

Tofu purees each having different physicochemical properties, that is, viscosity, dynamic storage elastic modulus, and dynamic loss elastic modulus, were prepared by a similar method to that of Example 1-1, except that the treatment pressure of the homogenizer was changed as follows. Physicochemical properties of the tofu purees concerning the conditions (a) to (d) are shown in Table 4.

### Comparative Example 2-1

The treatment pressure of the homogenizer was set at 0 MPa.

### Example 2-1

The treatment pressure of the homogenizer was set at 1 MPa.

### Example 2-2

The treatment pressure of the homogenizer was set at 12 MPa.

### Example 2-3

The treatment pressure of the homogenizer was set at 17 MPa.

### Comparative Example 2-2

The treatment pressure of the homogenizer was set at 20 MPa.

Next, 5 types of sample were prepared using each tofu puree and evaluated in the same way as in Example 1-1. The results are shown in Table 4.

TABLE 4

| | | (b) | (c) | | | | | | |
|---|---|---|---|---|---|---|---|---|---|
| | | Dynamic | Dynamic | (d) | (d) | | | | |
| | | storage | loss | Average | 90% | | | | |
| | (a) | elastic | elastic | particle | particle | | | Dripping | Shape |
| | Viscosity | modulus | modulus | diameter | diameter | | | start time | retainability |
| | (mPa · s) | (Pa) | (Pa) | (μm) | (μm) | Texture | Flavor | (minutes) | (minutes) |
| Comparative | 10 | 0.1 | 0.1 | 1.0 | 10.2 | Poor | Good | 35 | 75 |
| Example | | | | | | | | | |
| 2-1 | | | | | | | | | |
| Example | 20 | 0.2 | 0.2 | 2.0 | 15.3 | Good | Good | 63 | 98 |
| 2-1 | | | | | | | | | |
| Example | 1100 | 14.5 | 8.7 | 13.4 | 23.1 | Good | Good | 65 | 100 |
| 2-2 | | | | | | | | | |
| Example | 3000 | 600.0 | 250.0 | 15.0 | 35.0 | Good | Good | 72 | 110 |
| 2-3 | | | | | | | | | |
| Comparative | 4000 | 647.5 | 258.6 | 21.2 | 38.5 | Poor | Good | 75 | 112 |
| Example | | | | | | | | | |
| 2-2 | | | | | | | | | |

It is apparent from the results shown in Table 4 that the particular physicochemical properties give favorable characteristics in terms of texture, flavor, drip resistance, and shape retainability.

When other tests were carried out in the same way as described above, except that the kind of soymilk, coagulant, or emulsifying dispersion apparatus was suitably changed, similar results were obtained.

### Test Example 3

### Comparison of Content of Tofu Puree.

Test Example 3 was carried out to examine the influence of the content of the tofu puree on the characteristics of samples (obtained products).

Six types of sample were prepared in the same way as in Example 1-1, except that the content of the tofu puree was varied between 10 and 90% by mass with respect to the total mass of each sample, as shown in Table 5, and then the characteristics thereof were evaluated. The results are shown in Table 5.

TABLE 5

| | Content of tofu | | | | |
|---|---|---|---|---|---|
| | puree | | | Dripping start time | Shape retainability |
| | (%) | Texture | Flavor | (minutes) | (minutes) |
| Comparative | 10 | Poor | Good | 31 | 68 |
| Example | | | | | |
| 3-1 | | | | | |
| Example | 20 | Good | Good | 61 | 100 |
| 3-1 | | | | | |
| Example | 40 | Good | Good | 61 | 100 |
| 3-2 | | | | | |
| Example | 60 | Good | Good | 63 | 105 |
| 3-3 | | | | | |
| Example | 80 | Good | Good | 66 | 110 |
| 3-4 | | | | | |
| Comparative | 90 | Poor | Poor | 35 | 70 |
| Example | | | | | |
| 3-2 | | | | | |

It was confirmed by the results shown in Table 5 that the content of the tofu puree required for preparing a sample excellent in texture, flavor, drip resistance, and shape retainability is within a range from 20 to 80% by mass with respect to the total mass of the sample. When the content of the tofu puree was smaller than the lower limit shown above, the obtained product became inferior in terms of the texture, drip resistance, and shape retainability. On the other hand, when the content of the tofu puree was more than the upper limit shown above, the content of components other than the tofu puree became small, and so the obtained product became inferior in terms of the texture, flavor, drip resistance, and shape retainability.

When other tests were carried out in the same way as described above, except that the kind of soymilk, coagulant, or emulsifying dispersion apparatus was suitably changed, similar results were obtained.

### Test Example 4

### Comparison of Content of Oil and Fat Originating from Raw Material Other than Tofu Puree

Test Example 4 was carried out to examine the influence of the content of the oil and fat originating from a raw material other than the tofu puree on the characteristics of samples (obtained products).

Five types of sample were prepared in the same way as in Example 1-1, except that the content of the oil and fat originating from a raw material other than the tofu puree was changed between 0% and 20% by mass with respect to the total mass of each sample, as shown in Table 6, and then evaluated. The results are shown in Table 6.

TABLE 6

| | Content of oil | | | | |
|---|---|---|---|---|---|
| | and fat | | | Dripping start time | Shape retainability |
| | (%) | Texture | Flavor | (minutes) | (minutes) |
| Comparative | 0 | Poor | Good | 30 | 70 |
| Example | | | | | |
| 4-1 | | | | | |
| Example | 1 | Good | Good | 61 | 100 |
| 4-1 | | | | | |
| Example | 5 | Good | Good | 61 | 105 |
| 4-2 | | | | | |
| Example | 10 | Good | Good | 65 | 110 |
| 4-3 | | | | | |
| Example | 15 | Good | Good | 66 | 110 |
| 4-4 | | | | | |
| Comparative | 20 | Poor | Poor | 70 | 120 |
| Example | | | | | |
| 4-2 | | | | | |

It was confirmed by the results shown in Table 6 that the content of the oil and fat originating from a raw material other than the tofu puree required for preparing a sample excellent in texture, flavor, drip resistance, and shape retainability was within a range between 1% and 15% by mass with respect to the total mass of the sample. When the content of the oil and fat was smaller than the lower limit shown above, the obtained product became inferior in terms of the texture, drip resistance, and shape retainability. On the other hand, when the content of the oil and fat was more than the upper limit shown above, the obtained product became inferior in terms of the texture, flavor, drip resistance, and shape retainability.

When other tests were carried out in the same way as described above, except that the kind of oil and fat was suitably changed, similar results were obtained.

As is apparent from the results of the above examples, the samples prepared in the examples according to the present invention were a novel type of frozen dessert with an excellent texture, flavor, drip resistance, and shape retainability, none of these characteristics being exhibited by the prior arts.

According to the present invention, a frozen dessert excellent in drip resistance and shape retainability in addition to the texture and flavor can be provided.

What is claimed is:

1. A frozen dessert comprising:
20 to 80% by mass of a tofu puree comprising particles, the tofu puree having physicochemical properties of:
(a) viscosity of 20 to 3,000 mPa·s;
(b) dynamic storage elastic modulus of 0.2 to 600 Pa;
(c) dynamic loss elastic modulus of 0.2 to 250 Pa; and
(d) an average particle diameter of the particles of 2 to 15 μm and a 90% particle diameter thereof of 35 μm or smaller; and
1 to 15% by mass of an oil and fat originating from a raw material other than the tofu puree.
